(19) United States
(12) Patent Application Publication
(10) Pub. No.: US 2025/0390774 A1
(43) Pub. Date: Dec. 25, 2025

(54) QUANTUM CIRCUIT FOR SOLVING PAULI-BREIT HAMILTONIANS AND METHODS FOR USE THEREWITH

(71) Applicant: BEIT Sp. z o.o., Kraków (PL)

(72) Inventor: Emil Zak, Krakow (PL)

(73) Assignee: BEIT Sp. z o.o., Kraków (PL)

(21) Appl. No.: 19/231,791

(22) Filed: Jun. 9, 2025

Related U.S. Application Data
(60) Provisional application No. 63/662,558, filed on Jun. 21, 2024.

(51) Int. Cl. G06N 10/20

(52) U.S. Cl. CPC G06N 10/20

(57) ABSTRACT

A quantum circuit comprises: a first circuit primitive configured to prepare first qubits representing orbital indices in accordance with a first primitive matrix operation; a second circuit primitive configured to prepare second qubits representing spin indices in accordance with a second primitive matrix operation, wherein the spin indices are decoupled from the plurality of orbital indices; a plurality of spin-mixing swap networks configured to control the first qubits representing the orbital indices and the second qubits representing the spin indices; a third circuit primitive configured to implement, after the plurality of spin-mixing swap networks, a Hermitian conjugate of the first primitive matrix operation on the first qubits; and a fourth circuit primitive configured to implement, after the spin-mixing swap networks, a Hermitian conjugate of the second primitive matrix operation on the second qubits; wherein states of the first and second qubits estimate the eigenvalues of a PB Hamiltonian.

### CROSS-REFERENCE TO RELATED APPLICATIONS

The present U.S. Utility patent application claims priority pursuant to 35 U.S.C. § 119(e) to U.S. Provisional Application No. 63/662,558, entitled “QUANTUM CIRCUIT FOR SOLVING PAULI-BREIT HAMILTONIANS AND METHODS FOR USE THEREWITH”, filed Jun. 21, 2024, which is hereby incorporated herein by reference in its entirety and made part of the present U.S. Utility patent application for all purposes.

### BACKGROUND OF THE INVENTION

### Technical Field of the Invention

This invention relates generally to computer systems and particularly to quantum computing techniques and circuits.

### Description of Related Art

Computing devices are known to communicate data, process data, and/or store data. Such computing devices range from wireless smart phones, laptops, tablets, personal computers (PC), work stations, smart watches, connected cars, and video game devices, to web servers and data centers that support millions of web searches, web applications, or on-line purchases every day. In general, a computing device includes a processor, a memory system, user input/output interfaces, peripheral device interfaces, and an interconnecting bus structure.

Classical digital computing devices operate based on data encoded into binary digits (bits), each of which has one of the two definite binary states (i.e., 0 or 1). In contrast, a quantum computer utilizes quantum-mechanical phenomena to encode data as quantum bits or qubits, which can be in superpositions of the traditional binary states.

### BRIEF DESCRIPTION OF THE SEVERAL VIEWS OF THE DRAWING(S)

FIG. 1A is a block diagram of an example of a quantum computing architecture;

FIG. 1B is a block diagram of an example of a quantum circuit;

FIG. 2A is a block diagram of an example of a quantum circuit representation;

FIG. 2B is a block diagram of an example of a quantum circuit;

FIG. 2C-2G are block diagrams of an example of a quantum circuit primitive and components thereof;

FIG. 2H-2J are block diagrams of example of quantum circuit components;

FIG. 2K is a block diagram of an example of a spin-mixing swap network;

FIG. 2L is a block diagram of an example of a spin-mixing swap network component;

FIG. 2M is a block diagram of an example of a quantum circuit without spin-mixing; and

FIG. 2N-2P are block diagrams of example quantum circuit representations.

FIG. 3 is a flow diagram of an embodiment of a method in accordance with the present invention.

### DETAILED DESCRIPTION OF THE INVENTION

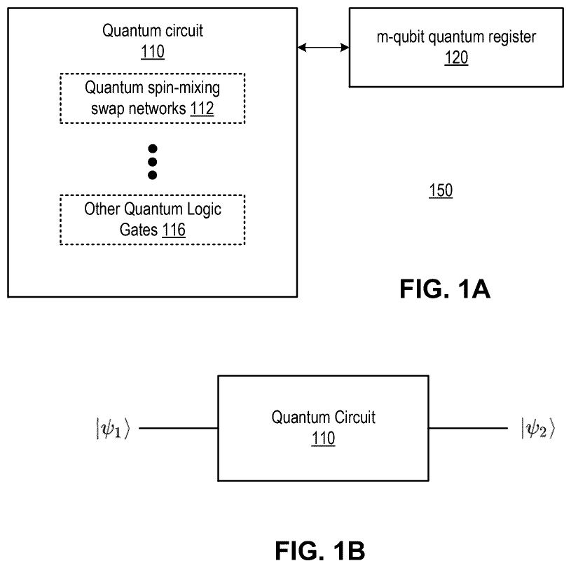

FIG. 1A is a block diagram of an example of a quantum computing architecture. In particular, a quantum circuit 110 is presented for solving a Pauli-Breit (PB) Hamiltonian that includes one or more quantum spin-mixing swap networks 112 and/or one or more other quantum logic gates 116 that operate on m qubits of a quantum register 120. The PB Hamiltonian can be used to describe relativistic effects occurring in quantum systems. One prominent example is the spin-orbit interaction that stems from the PB Hamiltonian. The spin-orbit interaction is ubiquitous in fields such as photo-material design, artificial photosynthesis, photodynamic cancer therapy, magnetic materials, spectra of molecules, etc.

The PB Hamiltonian consists of six terms:

$${\hat{H}}_{PB} = {\hat{H}}_{el .} + {\hat{H}}_{D 1} + {\hat{H}}_{D 2} + {\hat{H}}_{SO , 1} + {\hat{H}}_{SO , 2} + {\hat{H}}_{SS} where$$

$${\hat{H}}^{( el . )} = \frac{1}{2} {\sum }_{j = 1}^{η} {\hat{p}}_{j}^{2} - {\sum }_{j = 1}^{η} {\sum }_{α = 1}^{M} \frac{{Z}_{α}}{‖ {r}_{j} - {R}_{α} ‖} + {\sum }_{j < k}^{η} \frac{1}{‖ {r}_{j} - {r}_{k} ‖}$$

is the non-relativistic electronic Hamiltonian and

$${\hat{H}}^{( D 1 )} = \frac{π}{2} {\sum }_{j = 1}^{η} {\sum }_{α = 1}^{M} {Z}_{α} δ ( {r}_{j} - {R}_{α} ) - \frac{1}{8} {\sum }_{j = 1}^{η} {\hat{p}}_{j}^{4}$$

$${\hat{H}}^{( D 2 )} = - \frac{1}{2} {\sum }_{j < k}^{η} ( {p}_{j} \cdot [ \frac{( {r}_{j} - {r}_{k} ) ( {r}_{j} - {r}_{k} )}{{‖ {r}_{j} - {r}_{k} ‖}^{3}} + \frac{1}{‖ {r}_{j} - {r}_{k} ‖} ] \cdot {p}_{k} - πδ ( {r}_{j} - {r}_{k} ) )$$

are the one and two body Darwin terms,

$${\hat{H}}^{( SO , 1 )} = \frac{1}{2} {\sum }_{j = 1}^{η} {\sum }_{α = 1}^{M} \frac{{Z}_{α}}{{‖ {r}_{j} - {R}_{α} ‖}^{3}} {s}_{j} \cdot [ {l}_{j} - ( {R}_{α} \times {p}_{j} ) ]$$

$${\hat{H}}^{( SO , 2 )} = {\sum }_{j < k}^{η} \frac{( {s}_{j} + {s}_{k} )}{{‖ {r}_{j} - {r}_{k} ‖}^{3}} \cdot [ ( {r}_{j} - {r}_{k} ) \times ( {p}_{j} - {p}_{k} ) ]$$

are the one and two body spin-orbit interaction Hamiltonian, respectively and the spin-spin interaction Hamiltonian is given by

$${\hat{H}}^{( SS )} = {{\sum }_{j < k}}^{η} \frac{1}{{‖ {r}_{j} - {r}_{k} ‖}^{3}} {s}_{j} \cdot [ 3 \frac{( {r}_{j} - {r}_{k} ) ( {r}_{j} - {r}_{k} )}{{‖ {r}_{j} - {r}_{k} ‖}^{2}} - 1 ] \cdot {s}_{k} - \frac{8}{3} π δ ( {r}_{j} - {r}_{k} ) {s}_{j} {s}_{k}$$

In various examples, the action of the quantum circuit 110 on a specific quantum state can be found by processing an input vector, which represents the input qubit state, resulting in a new result is an output vector state representative of the eigenvalues of the particular PB Hamiltonian being simulated/modelled. As shown in FIG. 1B, the input vector state can be represented by:
   |ψ₁ [symbol]
   And the output vector state representative of the eigenvalues of the particular PB Hamiltonian can be represented by:
   |ψ₂

[symbol]

The various examples presented herein improve on the technology of quantum computing by providing a PB Hamiltonian represented in the second quantization formalism through the so-called triplet excitation operators, gaining a particularly compact form. The Majorana representation is used to express the PB Hamiltonian in the context of quantum computation. The PB Hamiltonian is thereby morphed into a linear combination of unitaries-a form suitable for quantum computer simulation.

The various examples presented herein improve on the technology of quantum computing by introducing a mapping between spin-orbitals and qubits that can be called ‘orbital major’ mapping, which carries certain advantages over the mapping used commonly in other techniques. The orbital major mapping produces a recipe for implementing Givens rotations that convert linear combinations of Majorana operators into a product of unitaries.

As used herein, “Givens rotations” are a type of matrix transformation used in linear algebra. They are named after Wallace Givens, who introduced them as a method for diagonalizing matrices. A Givens rotation is a 2×2 orthogonal matrix that can be used to introduce zeros in a matrix or to rotate vectors in a coordinate system.

As used herein, the “Majorana representation” is a mathematical technique used in quantum mechanics to describe the states of a system. It is named after the Italian physicist Ettore Majorana. This Majorana representation is generated from the particle creation/annihilation representation. It offers advantages of operators being self-inverse, unlike in the original creation/annihilation representation. The Majorana representation is particularly useful for systems with spin or angular momentum, where the states have both magnitude and direction.

The various examples presented herein also improve the technology of quantum computing by demonstrating a quantum circuit block-encoding of the PB Hamiltonian. Block-encoding also uses most quantum resources in the quantum phase estimation (QPE) algorithm. In doing so, new circuits are produced for the SELECT operation in block-encoding of the doubly-factorized PB Hamiltonian. These circuits reduce the quantum T-gate count from two to four times with respect to other techniques.

In various examples, a quantum circuit 110 for estimating eigenvalues of a Pauli-Breit (PB) Hamiltonian, includes:
a first circuit primitive configured to prepare a first plurality of qubits representing a plurality of orbital indices, in accordance with a first primitive matrix operation;
a second circuit primitive configured to prepare a second plurality of qubits representing a plurality of spin indices, in accordance with a second primitive matrix operation, wherein the plurality of spin indices are decoupled from the plurality of orbital indices;
a plurality of spin-mixing swap networks configured to control the first plurality of qubits representing the plurality of orbital indices and the second plurality of qubits representing the plurality of spin indices;
a third circuit primitive configured to implement, after the plurality of spin-mixing swap networks, a Hermitian conjugate of the first primitive matrix operation on the first plurality of qubits; and
a fourth circuit primitive configured to implement, after the plurality of spin-mixing swap networks, a Hermitian conjugate of the second primitive matrix operation on the second plurality of qubits;
wherein states of the first and second plurality of qubits are utilized in a phase estimation that retrieves the eigenvalues of the PB Hamiltonian.

In addition or in the alternative to any of the foregoing, the plurality of spin-mixing swap networks include a plurality of spin-generating operator circuits configured to control the second plurality of qubits representing the plurality of spin indices.

In addition or in the alternative to any of the foregoing, the plurality of spin-mixing swap networks further include a plurality of orbital-generating operator circuits configured to control the first plurality of qubits representing the plurality of orbital indices.

In addition or in the alternative to any of the foregoing, the plurality of spin-mixing swap networks operate in accordance with a linear combination of unitaries.

In addition or in the alternative to any of the foregoing, the linear combination of unitaries are in accordance with an orbital major mapping between the first and second plurality of qubits and spin-orbitals characterized by the plurality of spin indices and the plurality of orbital indices.

In addition or in the alternative to any of the foregoing, the linear combination of unitaries are generated in accordance with a linear combination of Majorana operators.

In addition or in the alternative to any of the foregoing, the linear combination of unitaries are generated further in accordance with Givens rotations.

In addition or in the alternative to any of the foregoing, the PB Hamiltonian is in accordance with triplet excitation operators.

In addition or in the alternative to any of the foregoing, the eigenvalues of the PB Hamiltonian are determined based on a block encoding of the PB Hamiltonian.

In addition or in the alternative to any of the foregoing, the eigenvalues of the PB Hamiltonian are determined based on a quantum phase estimation.

In addition or in the alternative to any of the foregoing, eigenvalues of the PB Hamiltonian can be found via a quantum circuit by:
Expressing the PB Hamiltonian in second quantization, within the framework of a spin-dependent Unitary Group technique;
Using double-factorization to reduce the number of terms in the PB Hamiltonian;
Expressing the PB Hamiltonian as a linear combination of unitaries with the use of the Majorana representation;
Block-encoding the PB Hamiltonian to feed it into a quantum phase estimation circuit;
Obtaining the eigenvalues of the PB Hamiltonian via quantum phase estimation.

Consider the following further examples, features and implementations presented below that can used in addition or in the alternative to any of the foregoing. An orthonormal spin-orbital basis can be chosen as:

$${B}_{N} = \{ \vert p σ 〉 \vert p = 1 , … , N ; σ = - \frac{1}{2} , + \frac{1}{2} \}$$

where p labels spatial orbitals and sigma labels the spin variable. Next fermionic ladder operators can be used to represent the PB Hamiltonian:

$${[ {\hat{a}}_{p σ}^{†} , {\hat{a}}_{q ρ} ]}_{+} = {δ}_{pq} {δ}_{σ ρ}$$

from which the U(2N) lie group generators are constructed:

$${\hat{E}}_{pq , σρ} = {\hat{a}}_{p σ}^{†} {\hat{a}}_{q ρ}$$

giving the one-body terms in the PB Hamiltonian in the following form:

$${\hat{H}}^{( 1 )} = {\sum }_{p , q = 1}^{N} {\sum }_{σ , ρ = \pm \frac{1}{2}} 〈 p , σ \vert {\hat{H}}^{( 1 )} \vert q , ρ 〉 {\hat{E}}_{pq , σρ}$$

The two-body terms are given as:

$${\hat{H}}^{( 2 )} = \frac{1}{2} {\sum }_{p , q , r , s = 1}^{N} {\sum }_{σ , ρ , τ , v = \pm \frac{1}{2}} 〈 pq σρ \vert {\hat{H}}^{( 2 )} \vert rs τν 〉 ( {\hat{E}}_{pr , στ} {\hat{E}}_{qs , ρ v} - {δ}_{qr} {δ}_{p τ} {\hat{E}}_{ps , σ v} )$$

The one-body part of the PB Hamiltonian can be written as:

$${\hat{H}}^{( 1 )} = {\sum }_{μ = X , Y , Z , 0} {\sum }_{σ , ρ} {\sum }_{p , q} {\hat{P}}_{σ ρ}^{( μ )} {H}_{pq}^{( 1 , μ )} {\hat{E}}_{p σ q ρ}$$

$$where$$

$${H}_{pq}^{( 1 , μ )} = 〈 p \vert {δ}_{μ 0} ( {\hat{T}}^{( e )} + {\hat{V}}^{( ne )} + {\hat{H}}^{( D 1 )} ) + \frac{1}{2} ( 1 - {δ}_{μ 0} ) {\hat{H}}^{( orb , 1 , μ )} \vert q 〉$$

are

$${\hat{P}}_{σ ρ}^{( μ )}$$

elements of the μ-th Pauli matrix. As an auxiliary object we define a vector of Pauli and matrices as:

$$\hat{P} = ( \begin{matrix}1 \\ \hat{X} \\ \hat{Y} \\ \hat{Z}\end{matrix} )$$

The two-body part of the PB Hamiltonian is then given as:

$${\hat{H}}^{( 2 )} = {\sum }_{μ , {μ}^{′} = 0 , X , Y , Z} {\sum }_{p , q , r , s} {\sum }_{σ , ρ , τ , v} [ {δ}_{μ 0} {δ}_{0 {μ}^{′}} {\hat{P}}_{σ ρ}^{( 0 )} {\hat{P}}_{τ v}^{( 0 )} ( {\hat{E}}_{p σ q ρ} {\hat{E}}_{ττ sv} \frac{1}{2} 〈 pq \vert {\hat{V}}^{( ee )} + {\hat{H}}^{( D 2 )} \vert rs 〉 - \qquad ( 40 )$$

$$- {\hat{E}}_{p σ q ρ} {\hat{E}}_{ττ sv} \frac{1}{4} 〈 pq \vert {\hat{H}}^{( cont )} \vert rs 〉 ) + \qquad ( 41 )$$

$$+ ( 1 - {δ}_{0 {μ}^{′}} - {δ}_{0 μ} + {δ}_{0 μ} {δ}_{0 {μ}^{′}} ) {\hat{P}}_{σρ}^{( μ )} {\hat{P}}_{τ v}^{( μ )} {\hat{E}}_{p σ q ρ} {\hat{E}}_{ττ sv} \frac{1}{2} 〈 pq \vert {\hat{H}}^{( SS , {μμ}^{′} )} \vert rs 〉 + \qquad ( 42 )$$

$$+ {δ}_{0 {μ}^{′}} ( 1 - {δ}_{μ0} ) {\hat{P}}_{σρ}^{( μ )} {\hat{P}}_{τ v}^{( {μ}^{′} )} {\hat{E}}_{p σ q ρ} {\hat{E}}_{ττ s v} \frac{1}{2} 〈 pq \vert {\hat{H}}^{( orb , 2 , μ )} \vert rs 〉 + \qquad ( 43 )$$

$$+ {δ}_{0 μ} ( 1 - {δ}_{{μ}^{′} 0} ) {\hat{P}}_{σρ}^{( μ )} {\hat{P}}_{τ v}^{( {μ}^{′} )} {\hat{E}}_{p ττ v} {\hat{E}}_{q σ s ρ} \frac{1}{2} 〈 pq \vert {\hat{H}}^{( orb , 2 , {μ}^{′} )} \vert rs 〉 ] \qquad ( 44 )$$

$$where$$

$${\hat{H}}^{( Orb , 2 )} = \frac{1}{{‖ {r}_{j} - {r}_{k} ‖}^{3}} \cdot [ ( {r}_{j} - {r}_{k} ) \times ( {p}_{j} - {p}_{k} ) ]$$

$${\hat{H}}^{( Orb , 1 )} = \frac{1}{2} {\sum }_{α = 1}^{M} \frac{{Z}_{α}}{{‖ {r}_{j} - {R}_{o} ‖}^{3}} \cdot [ {I}_{j} - ( {R}_{α} \times {p}_{j} ) ]$$

The triplet excitation operators can be defined as:

$${T}_{pq}^{( μ )} = {\sum }_{σ , ρ} {\hat{P}}_{σ ρ}^{( μ )} {\hat{E}}_{p σ q ρ}$$

with the one and two body PB operators expressed as:

$${\hat{H}}^{( 1 )} = {\sum }_{p , q} {H}_{pq}^{( 1 )} {\hat{\tilde{T}}}_{pq}$$

$$where$$

$${H}^{( 1 )} = ( \begin{matrix}{\hat{T}}^{( e )} + {\hat{T}}^{( nc )} + {\hat{H}}^{( D 1 )} \\ {\hat{H}}^{( orb , 1 , X )} \\ {\hat{H}}^{( orb , 1 , Y )} \\ {\hat{H}}^{( orb , 1 , Z )}\end{matrix} )$$

### Two Body Part:

$${\hat{H}}^{( 2 )} = {\sum }_{μ , {μ}^{′} = 0 , X , Y , Z} {\sum }_{p , q , r , s} {C}_{{μμ}^{′}} {\hat{\tilde{T}}}_{pq}^{( μ )} {\hat{G}}_{pqrs}^{( {μμ}^{′} )} {\hat{\tilde{T}}}_{rs}^{( {μ}^{′} )}$$

$$where$$

$$\hat{G} = \frac{1}{2} ( \begin{matrix}{\hat{V}}^{( ee )} + {\hat{H}}^{( D 2 )} - \frac{1}{2} {\hat{H}}^{( cont )} & {\hat{H}}^{( orb , 2 , x )} & {\hat{H}}^{( orb , 2 , y )} & {\hat{H}}^{( orb , 2 , z )} \\ {\hat{H}}^{( orb , 1 , X )} & {\hat{H}}^{( SS , XX )} & {\hat{H}}^{( SS , xy )} & {\hat{H}}^{( SS , xx )} \\ {\hat{H}}^{( orb , 1 , Y )} & {\hat{H}}^{( SS , yx )} & {\hat{H}}^{( SS , yy )} & {\hat{H}}^{( SS , yz )} \\ {\hat{H}}^{( orb , 1 , Z )} & {\hat{H}}^{( SS , zx )} & {\hat{H}}^{( SS , zy )} & {\hat{H}}^{( SS , zz )}\end{matrix} )$$

$$C = ( \begin{matrix}{δ}_{μ 0} {δ}_{0 {μ}^{′}} & {δ}_{0 μ} ( 1 - {δ}_{{μ}^{′} 0} ) & {δ}_{0 μ} ( 1 - {δ}_{{μ}^{′} 0} ) & {δ}_{0 μ} ( 1 - {δ}_{{μ}^{′} 0} ) \\ {δ}_{0 {μ}^{′}} ( 1 - {δ}_{μ 0} ) & ( 1 - {δ}_{0 {μ}^{′}} - {δ}_{μ 0} + {δ}_{μ 0} {δ}_{0 {μ}^{′}} ) & ( 1 - {δ}_{0 {μ}^{′}} - {δ}_{μ 0} + {δ}_{μ 0} {δ}_{0 {μ}^{′}} ) & ( 1 - {δ}_{0 {μ}^{′}} - {δ}_{μ 0} + {δ}_{μ 0} {δ}_{0 {μ}^{′}} ) \\ {δ}_{0 {μ}^{′}} ( 1 - {δ}_{μ 0} ) & ( 1 - {δ}_{0 {μ}^{′}} - {δ}_{μ 0} + {δ}_{μ 0} {δ}_{0 {μ}^{′}} ) & ( 1 - {δ}_{0 {μ}^{′}} - {δ}_{μ 0} + {δ}_{μ 0} {δ}_{0 {μ}^{′}} ) & ( 1 - {δ}_{0 {μ}^{′}} - {δ}_{μ 0} + {δ}_{μ 0} {δ}_{0 {μ}^{′}} ) \\ {δ}_{0 {μ}^{′}} ( 1 - {δ}_{μ 0} ) & ( 1 - {δ}_{0 {μ}^{′}} - {δ}_{μ 0} + {δ}_{μ 0} {δ}_{0 {μ}^{′}} ) & ( 1 - {δ}_{0 {μ}^{′}} - {δ}_{μ 0} + {δ}_{μ 0} {δ}_{0 {μ}^{′}} ) & ( 1 - {δ}_{0 {μ}^{′}} - {δ}_{μ 0} + {δ}_{μ 0} {δ}_{0 {μ}^{′}} )\end{matrix} )$$

The Majorana representation can be expressed as follows:

$${\hat{γ}}_{p σ0} = {\hat{a}}_{p σ} + {\hat{a}}_{p σ}^{†}$$

$${\hat{γ}}_{p σ 1} = - i ( {\hat{a}}_{p σ} - {\hat{a}}_{p σ}^{†} )$$

$${[ {\hat{γ}}_{p σ u} , {\hat{γ}}_{q ρ v} ]}_{+} = 2 {δ}_{pq} {δ}_{σρ} {δ}_{uv}$$

giving a set of Hermitian and anticommuting operators. With this new set of operators can be expressed via the one body spin-orbit Hamiltonian as

$${\hat{H}}^{( SO , 1 , X )} = \frac{i}{4} {\sum }_{p , q = 1}^{N} {H}_{p , q}^{( SO , 1 , X )} {\sum }_{σ , ρ} {\hat{γ}}_{p σ0} {P}_{σρ}^{( 1 )} {\hat{γ}}_{q ρ1} \qquad ( I . a )$$

$${\hat{H}}^{( SO , 1 , Y )} = \frac{i}{4} {\sum }_{p , q = 1}^{N} {H}_{p , q}^{( SO , 1 , Y )} {\sum }_{σ , ρ} {\hat{γ}}_{p σ0} {P}_{σρ}^{( 2 )} {\hat{γ}}_{q ρ1} + \hat{R}$$

$${\hat{H}}^{( SO , 1 , Z )} = \frac{i}{4} {\sum }_{p , q = 1}^{N} {H}_{p , q}^{( SO , 1 , Z )} {\sum }_{σ , ρ} {\hat{γ}}_{p σ0} {P}_{σρ}^{( 3 )} {\hat{γ}}_{q ρ1}$$

$$where$$

$$\hat{R} = - {\sum }_{p = 1}^{N} {\sum }_{σ , ρ} {\sum }_{s , t} {\hat{H}}_{p , p}^{( SO , 1 , Y )} ( {\hat{γ}}_{p σ s} {\hat{P}}_{σρ}^{( 1 )} {\hat{γ}}_{ppt} ( {1}_{st} + {\hat{X}}_{st} ) )$$

Double-factorization of the PB Hamiltonian in the Majorana representation can be expressed as follows. In particular, the matrix elements in the one-body part of the PB Hamiltonian can be factorized into a sum-of-products of rank-1 matrices in the following way:

$${H}_{p σ q ρ}^{( 1 )} = {{\sum }_{l = 1}}^{2 N} {f}_{l} {{v}_{p σ}^{( l )} ( {v}_{q ρ}^{( l )} )}^{T} \qquad ( II )$$

which transforms the original Hamiltonian given in the Majorana representation into a sum of the following unitaries, each of which acts on all spin-orbital qubit registers:

$$\hat{H} ( 1 ) = {\sum }_{l = 1}^{2 N} {f}_{l} {\hat{γ}}_{l 0} {\hat{γ}}_{l 1} \qquad ( I . b )$$

$$where$$

$${\hat{γ}}_{lx} = {\sum }_{p = 1}^{N} {\sum }_{σ = 0}^{1} {v}_{p σ}^{( l )} {\hat{γ}}_{p σ x}$$

The two-body Hamiltonian can be factorized into rank-1 operators by applying the tensor-decomposition-truncation procedure twice:

$${\hat{H}}^{( 2 )} = {{\sum }^{R}}_{r = 1} {( {λ}_{r}^{( 1 )} )}^{2} {T}_{2} [ \frac{{\hat{h}}_{f ( r )}^{( 1 )}}{{λ}_{r}^{( 1 )}} ] \qquad ( I . c )$$

$${\hat{h}}_{f ( r )}^{( 1 )} = {{\sum }^{L}}_{l = 1} {f}_{t}^{( r )} {{\sum }^{N}}_{p , q = 1} {\sum }_{σ , ρ} {{υ}_{p σ}^{( l , r )} ( {υ}_{q ρ}^{( l , r )} )}^{T} {\hat{γ}}_{p σ 0}^{A} {\hat{γ}}_{q ρ 1}$$

$$where$$

$${T}_{2} ( x ) = 2 {x}^{2} - 1$$

is the Chebyshev polynomial of the first kind and λᵣ is the norm of the one body component operator. In this example, Equations (I.a)-(I.c) above give explicit forms of the PB Hamiltonian in the Majorana representation.

The following ordering of the spin-orbital basis set that keeps indices of spin-orbitals with opposite spins close to each other:

$${ℬ}_{OM} = \{ \vert 1 α 〉 , \vert 1 β 〉 , \vert 2 α 〉 , \vert 2 β 〉 , … , \vert N α 〉 , \vert N β 〉 \}$$

called the orbital-major mapping from here on in. The corresponding Jordan-Wigner transformation is then given as

$${\hat{α}}_{p σ} = {\hat{α}}_{2 ( p - 1 ) + σ} = {⊗}_{j = 0}^{2 ( p - 1 ) + σ - 1} {\hat{Z}}_{j} ⊗ {\hat{σ}}_{2 ( p - 1 ) + σ}^{+} ⊗ {\hat{1}}_{2 ( p - 1 ) + σ + 1} ⊗ … ⊗ {\hat{1}}_{2 N} \qquad OM$$

Based on this encoding, the following coupling scheme can be employed for the generators of the unitary folding transformation:

$$𝒞 ( k ) : ℕ \to {ℕ}_{:}$$

$$\hat{γ} k α x \hat{γ} k β x \to \hat{γ} k β x \hat{γ} k + 1 α x \to \hat{γ} k + 1 α x \hat{γ} k + 1 β x \to …$$

which is used to create operators that transform linear combinations of Majorana operators into a product of unitaries, as shown in the three equations given below:

$$\hat{γ} lx = {\sum }_{p = 1}^{N} {\sum }_{σ = 0}^{1} {v}_{p σ}^{( l )} \hat{γ} p σ x = {\tilde{U}}_{σ , x}^{( l )} {\hat{g}}_{x} {\tilde{U}}_{σ , x}^{( l ) †}$$

$${\tilde{U}}_{x}^{( l )} = {\prod }_{p = 1}^{2 N - 1} {\hat{V}}_{x}^{( p )} ( {θ}_{{l}_{p}} )$$

$${\hat{V}}_{x}^{( p )} ( {θ}_{l p} ) = exp ( {θ}_{lp} {\hat{γ}}_{𝒞 ( p ) x} {\hat{γ}}_{𝒞 ( p + 1 ) x} ) = {\hat{C}}_{𝒞 ( p ) x} exp ( {\tilde{θ}}_{l p} {\hat{Z}}_{𝒞 ( p )} ) {\hat{C}}_{𝒞 ( p ) x \}}^{†}$$

$$where$$

$${\hat{C}}_{p}^{( 1 )} ( x ) := {\hat{X}}_{p} \cdot \frac{{( - 1 )}^{x} - 1}{2} - i {\hat{Y}}_{p} \cdot \frac{1 + {( - 1 )}^{x}}{2}$$

$${\hat{C}}_{N + q}^{( 2 )} ( y ) := {\hat{X}}_{N + q} \cdot \frac{1 + {( - 1 )}^{y}}{2} - i {\hat{Y}}_{N + q} \cdot \frac{1 - {( - 1 )}^{y}}{2}$$

and where the angles theta are calculated based on elements of vectors v given in Equation (II).

In various examples, the block-encoding circuit

$$B [ \frac{\hat{H}}{{‖ \hat{H} ‖}_{1}} ]$$

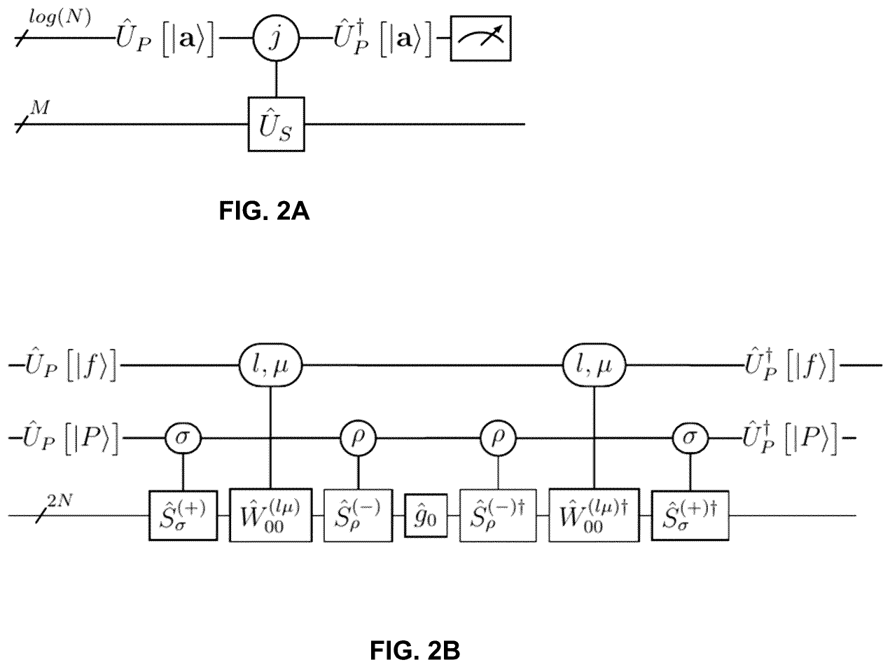

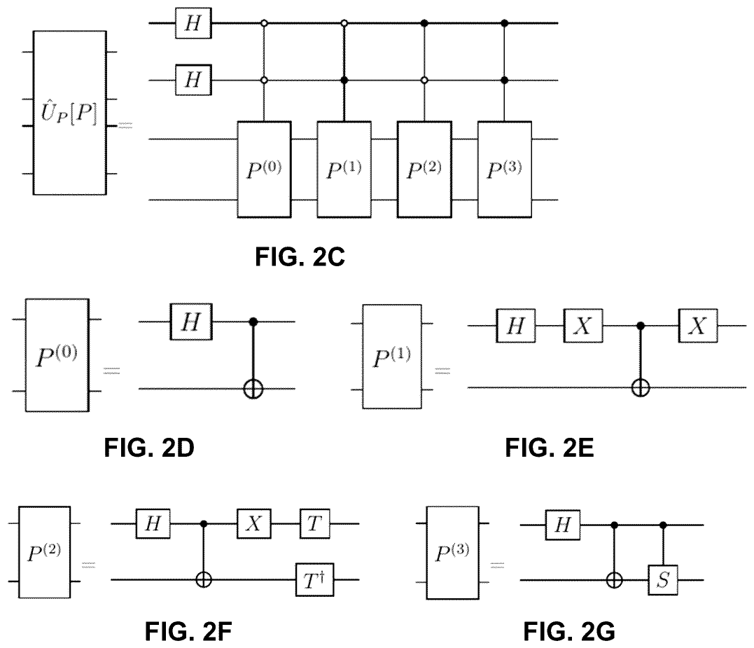

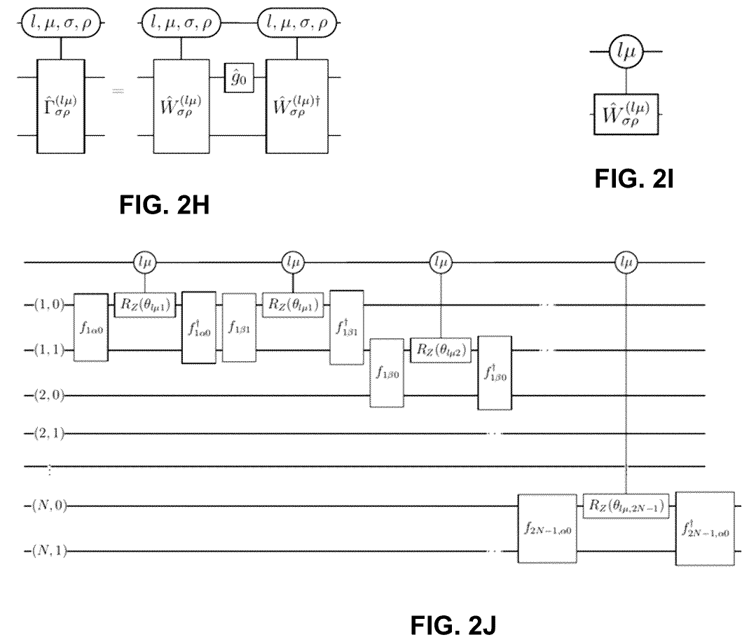

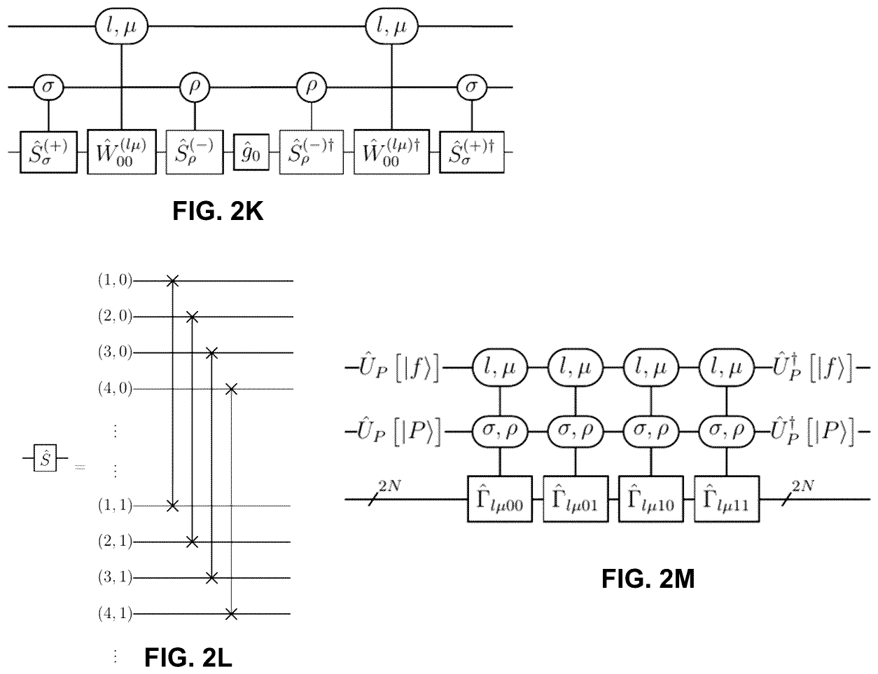

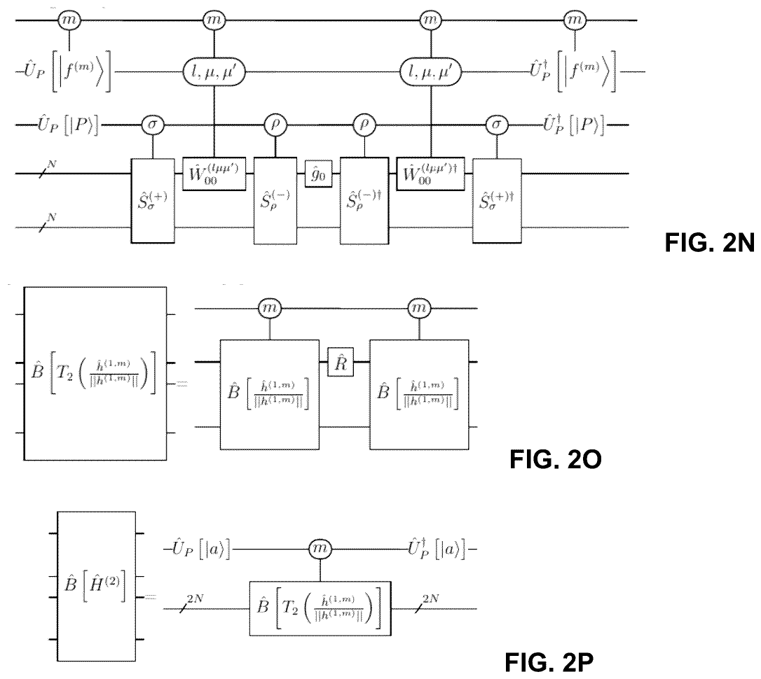

can be represented schematically as shown in FIG. 2A. Furthermore, the block-encoding of the one-body part of the PB Hamiltonian can be written as:

$${\hat{H}}^{( 1 )} = {\sum }_{l = 1}^{N} {\sum }_{μ = 0}^{3} {f}_{l μ} {\sum }_{σ , ρ = 0}^{1} {P}_{σ ρ}^{( μ )} {\hat{Γ}}_{σ ρ}^{( l μ )}$$

$$where$$

$${Γ}_{σ ρ}^{( l μ )} = \hat{γ} l μσ 0 \hat{γ} l μρ 1$$

An example of quantum circuit 110 is further presented via the block-encoding of the PB Hamiltonian shown in FIG. 2B. Circuit primitives for the PREP part of the block encoding circuit are shown in FIG. 2C, where

$$\sqrt{{P}_{σ ρ}^{( μ )}} \to {P}^{0} , {P}^{1} , {P}^{2} , {P}^{3}$$

as shown in FIGS. 2D-2G. This PREP circuit primitive prepares the following state:

$$\vert P 〉 = {\sum }_{μ = X , Y , Z , 0} {\sum }_{σ , ρ} \sqrt{{P}_{σ p}^{( μ )}} \vert σρμ 〉$$

One possible circuit (e.g., a ‘naïve’ form) for the SELECT part of the block encoding circuit can be illustrated as shown in FIG. 2H, where the circuit of FIG. 2I can be implemented as shown in FIG. 2J, with ‘f’s being Clifford operations. The spin indices sigma and rho in the above circuit can be decoupled from the orbital indices lambda and mu as shown in FIG. 2K, where

$${\hat{W}}_{σ ρ}^{( l μ )} = {\tilde{U}}_{σ , 0}^{( l μ )} {\tilde{U}}_{ρ , 1}^{( l μ )} = {\hat{S}}_{σ}^{( + )} {\tilde{U}}_{0 , 0}^{( l μ )} {\tilde{U}}_{0 , 1}^{( l μ )} {\hat{S}}_{ρ}^{( − )}$$

such that

$${\hat{Γ}}_{σ ρ}^{( l μ )} = {\hat{S}}_{σ}^{( + )} {\tilde{U}}_{0 , 0}^{( l μ )} {\tilde{U}}_{0 , 1}^{( l μ )} {\hat{S}}_{ρ}^{( - )} {\hat{g}}_{0} {\hat{S}}_{ρ}^{( - ) †} {\tilde{U}}_{0 , 1}^{( l μ ) †} {\tilde{U}}_{0 , 0}^{( l μ ) †} {\hat{S}}_{σ}^{( + ) †}$$

The spin-generating operators can be written as:

$${\hat{S}}_{σ}^{( \pm )} = {\prod }_{p = 1}^{N} SWAP [ p , p + N ] {δ}_{σ 1} + 1 {δ}_{σ , 0}$$

or in qubit notation:

$$\hat{S} = \vert 1 〉 〈 1 \vert ⊗ {\prod }_{p = 1}^{N} SWAP [ p , p + N ] + \vert 0 〉 〈 0 \vert ⊗ {1}_{2 N}$$

and the product of SWAP operations is given by the circuit of FIG. 2L.

In various examples, the quantum circuit 110 generates the following map:

$${\hat{S}}_{σ ρ} : {\prod }_{p = 1}^{N − 1} {\hat{V}}_{0 , 0}^{( p )} ( {θ}_{l μ p} ) {\hat{V}}_{0 , 1}^{( p )} ( {θ}_{l μ p} ) \to {\prod }_{p = 1}^{N − 1} {\hat{V}}_{σ , 0}^{( p )} ( {θ}_{l μ p} ) {\hat{V}}_{ρ , 1}^{( p )} ( {θ}_{l μ p} )$$

$$where$$

$${\tilde{U}}_{σ , x}^{( l μ )} = {\prod }_{p = 1}^{N − 1} {\hat{V}}_{σ , x}^{( p )} ( {θ}_{l μ p} )$$

$${\hat{V}}_{σ , x}^{( p )} ( {θ}_{l μ p} ) = exp ( {θ}_{l μ p} {\hat{γ}}_{p σ x} {\hat{γ}}_{p + 1 σ x} ) = {\hat{C}}_{p σ x} exp ( {\tilde{θ}}_{l μ p} {\hat{Z}}_{N σ + p} ) {\hat{C}}_{p σ x}^{†}$$

Implementing the one-body spin-dependent part of the Pauli-Breit Hamiltonian (e.g. the spin-orbit interaction) in a ‘naive’ way, yields the block-encoding circuit of FIG. 2M. In contrast, the complexity of the ‘naive’ circuit can be reduced by introducing spin-mixing SWAP networks as shown in FIG. 2B. Using the quantum circuit of FIG. 2B in place of a ‘naive’ circuit of FIG. 2M reduces the T-gate complexity about 4× and about 2× for other implementations.

The two-body part of the PB Hamiltonian can be implemented as follows. First the one-body components composing the factorized two-body Hamiltonian can be block-encoded with the circuit of FIG. 2N. The corresponding equation that this circuit block-encodes is given by:

$${\hat{h}}^{( 1 , m )} = \frac{i}{4} {\sum }_{l = 0}^{L ( m )} {f}^{( m , l , μ , {μ}^{′} )} {\sum }_{σ ρ} {\hat{Γ}}_{σ ρ}^{( m , l , μ , {μ}^{′} )}$$

$$where$$

$${\hat{Γ}}_{σ ρ}^{( m , l , μ , {μ}^{′} )} = \vec{γ} m , l , μ , {μ}^{′} σ , 0 \vec{γ} m , l , μ , {μ}^{′} ρ , 1$$

$$and$$

$${\sum }_{p} {v}_{p , σ , 0}^{( m , l , μ , {μ}^{′} )} {γ}_{p σ 0} := {\vec{γ}}_{m , l , σ , μ , {μ}^{′} , 0}$$

The block-encoded one-body component Hamiltonians can then be combined in a procedure called qubitization to give the block encoding of the second Chebyschev polynomial function shown in FIG. 2O. Finally, another block-encoding procedure that can be written as the circuit of FIG. 2P, completes the process of block-encoding the two-body PB Hamiltonian.

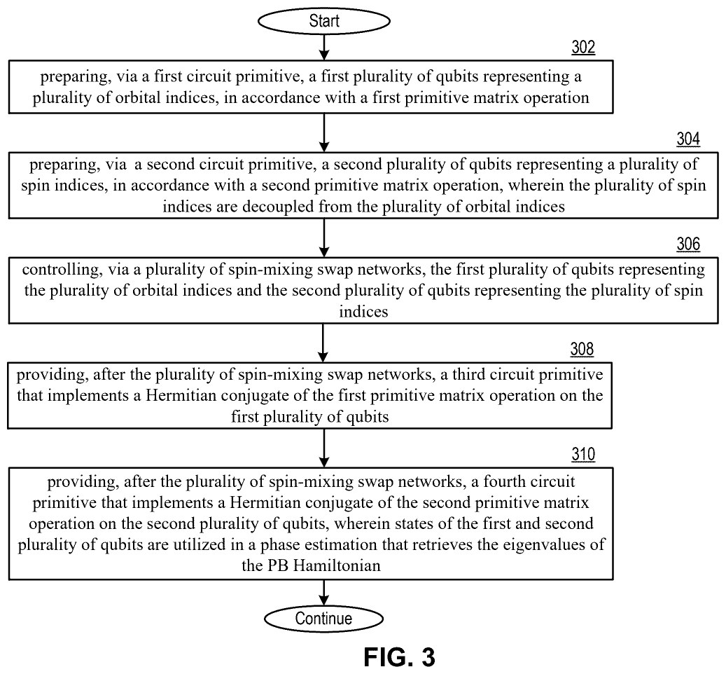

FIG. 3 is a flow diagram of an example method. In particular, a method is presented for use in a quantum circuit configured to process n qubits and d additional qubits and furthermore for use with one or more functions and features described in conjunctions with FIGS. 1A, 1B, 2B and the further descriptions above. Step 302 includes preparing, via a first circuit primitive, a first plurality of qubits representing a plurality of orbital indices, in accordance with a first primitive matrix operation. Step 304 includes preparing, via a second circuit primitive, a second plurality of qubits representing a plurality of spin indices, in accordance with a second primitive matrix operation, wherein the plurality of spin indices are decoupled from the plurality of orbital indices. Step 306 includes controlling, via a plurality of spin-mixing swap networks, the first plurality of qubits representing the plurality of orbital indices and the second plurality of qubits representing the plurality of spin indices. Step 308 includes providing, after the plurality of spin-mixing swap networks, a third circuit primitive that implements a Hermitian conjugate of the first primitive matrix operation on the first plurality of qubits. Step 310 includes providing, after the plurality of spin-mixing swap networks, a fourth circuit primitive that implements a Hermitian conjugate of the second primitive matrix operation on the second plurality of qubits, wherein states of the first and second plurality of qubits are utilized in a phase estimation that retrieves the eigenvalues of the PB Hamiltonian.

In addition or in the alternative to any of the foregoing, the plurality of spin-mixing swap networks include a plurality of spin-generating operator circuits configured to control the second plurality of qubits representing the plurality of spin indices.

In addition or in the alternative to any of the foregoing, the plurality of spin-mixing swap networks further include a plurality of orbital-generating operator circuits configured to control the first plurality of qubits representing the plurality of orbital indices.

In addition or in the alternative to any of the foregoing, the plurality of spin-mixing swap networks operate in accordance with a linear combination of unitaries.

In addition or in the alternative to any of the foregoing, the linear combination of unitaries are in accordance with an orbital major mapping between the first and second plurality of qubits and spin-orbitals characterized by the plurality of spin indices and the plurality of orbital indices.

In addition or in the alternative to any of the foregoing, the linear combination of unitaries are generated in accordance with a linear combination of Majorana operators.

In addition or in the alternative to any of the foregoing, the linear combination of unitaries are generated further in accordance with Givens rotations.

In addition or in the alternative to any of the foregoing, the PB Hamiltonian is in accordance with triplet excitation operators.

In addition or in the alternative to any of the foregoing, the eigenvalues of the PB Hamiltonian are determined based on a block encoding of the PB Hamiltonian.

In addition or in the alternative to any of the foregoing, the eigenvalues of the PB Hamiltonian are determined based on a quantum phase estimation.

In addition or in the alternative to any of the foregoing, eigenvalues of the PB Hamiltonian can be found via a quantum circuit by:
Expressing the PB Hamiltonian in second quantization, within the framework of a spin-dependent Unitary Group technique;
Using double-factorization to reduce the number of terms in the PB Hamiltonian;
Express the PB Hamiltonian as a linear combination of unitaries with the use of the Majorana representation;
Block-encoding the PB Hamiltonian to feed it into a quantum phase estimation circuit;
Obtaining the eigenvalues of the PB Hamiltonian via quantum phase estimation.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A quantum circuit for estimating eigenvalues of a Pauli-Breit (PB) Hamiltonian, the quantum circuit comprising:
a first circuit primitive configured to prepare a first plurality of qubits representing a plurality of orbital indices, in accordance with a first primitive matrix operation;
a second circuit primitive configured to prepare a second plurality of qubits representing a plurality of spin indices, in accordance with a second primitive matrix operation, wherein the plurality of spin indices are decoupled from the plurality of orbital indices;
a plurality of spin-mixing swap networks configured to control the first plurality of qubits representing the plurality of orbital indices and the second plurality of qubits representing the plurality of spin indices;
a third circuit primitive configured to implement, after the plurality of spin-mixing swap networks, a Hermitian conjugate of the first primitive matrix operation on the first plurality of qubits; and
a fourth circuit primitive configured to implement, after the plurality of spin-mixing swap networks, a Hermitian conjugate of the second primitive matrix operation on the second plurality of qubits;
wherein states of the first and second plurality of qubits estimate the eigenvalues of the PB Hamiltonian.

2. The quantum circuit of claim 1, wherein the plurality of spin-mixing swap networks include:
a plurality of spin-generating operator circuits configured to control the second plurality of qubits representing the plurality of spin indices.

3. The quantum circuit of claim 2, wherein the plurality of spin-mixing swap networks further include:
a plurality of orbital-generating operator circuits configured to control the first plurality of qubits representing the plurality of orbital indices.

4. The quantum circuit of claim 1, wherein the plurality of spin-mixing swap networks operate in accordance with a linear combination of unitaries.

5. The quantum circuit of claim 4, wherein the linear combination of unitaries are in accordance with an orbital major mapping between the first and second plurality of qubits and spin-orbitals characterized by the plurality of spin indices and the plurality of orbital indices.

6. The quantum circuit of claim 5, wherein the linear combination of unitaries are generated in accordance with a linear combination of Majorana operators.

7. The quantum circuit of claim 6, wherein the linear combination of unitaries are generated further in accordance with Givens rotations.

8. The quantum circuit of claim 1, wherein the PB Hamiltonian is in accordance with triplet excitation operators.

9. The quantum circuit of claim 1, the eigenvalues of the PB Hamiltonian are determined based on a block encoding of the PB Hamiltonian.

10. The quantum circuit of claim 1, the eigenvalues of the PB Hamiltonian are determined based on a quantum phase estimation.

11. A method for estimating eigenvalues of a Pauli-Breit (PB) Hamiltonian, the method comprising:
preparing, via a first circuit primitive, a first plurality of qubits representing a plurality of orbital indices, in accordance with a first primitive matrix operation;
preparing, via a second circuit primitive, a second plurality of qubits representing a plurality of spin indices, in accordance with a second primitive matrix operation, wherein the plurality of spin indices are decoupled from the plurality of orbital indices;
controlling, via a plurality of spin-mixing swap networks, the first plurality of qubits representing the plurality of orbital indices and the second plurality of qubits representing the plurality of spin indices;
providing, after the plurality of spin-mixing swap networks, a third circuit primitive that implements a Hermitian conjugate of the first primitive matrix operation on the first plurality of qubits; and
providing, after the plurality of spin-mixing swap networks, a fourth circuit primitive that implements a Hermitian conjugate of the second primitive matrix operation on the second plurality of qubits;
wherein states of the first and second plurality of qubits estimate the eigenvalues of the PB Hamiltonian.

12. The method of claim 11, wherein the plurality of spin-mixing swap networks include:
a plurality of spin-generating operator circuits configured to control the second plurality of qubits representing the plurality of spin indices.

13. The method of claim 12, wherein the plurality of spin-mixing swap networks further include:
a plurality of orbital-generating operator circuits configured to control the first plurality of qubits representing the plurality of orbital indices.

14. The method of claim 11, wherein the plurality of spin-mixing swap networks operate in accordance with a linear combination of unitaries.

15. The method of claim 14, wherein the linear combination of unitaries are in accordance with an orbital major mapping between the first and second plurality of qubits and spin-orbitals characterized by the plurality of spin indices and the plurality of orbital indices.

16. The method of claim 15, wherein the linear combination of unitaries are generated in accordance with a linear combination of Majorana operators.

17. The method of claim 16, wherein the linear combination of unitaries are generated further in accordance with Givens rotations.

18. The method of claim 11, wherein the PB Hamiltonian is in accordance with triplet excitation operators.

19. The method of claim 11, the eigenvalues of the PB Hamiltonian are determined based on a block encoding of the PB Hamiltonian.

20. The method of claim 11, the eigenvalues of the PB Hamiltonian are determined based on a quantum phase estimation.
